(19) United States
(12) Patent Application Publication
(10) Pub. No.: US 2026/0203098 A1
(43) Pub. Date: Jul. 16, 2026

(54) PARTIAL MIGRATION OF APPLICATIONS TO THE CLOUD

(71) Applicant: OpenLegacy Technologies Ltd., Princeton, NJ (US)

(72) Inventors: Zeev AVIDAN HERMAN, Petah Tikvah (IL); Roi MOR, Petah Tikva (IL)

(73) Assignee: OpenLegacy Technologies Ltd., Princeton, NJ (US)

(21) Appl. No.: 19/134,391

(22) PCT Filed: Jan. 17, 2023
(86) PCT No.: PCT/US2023/060734

§ 371 Date: May 30, 2025

(51) Int. Cl. G06F 9/48

(52) U.S. Cl. CPC G06F 9/4856; G06F 2209/482

(57) ABSTRACT

Partial application migration to the cloud is provided. An application configured for execution on a mainframe system is partially migrated to a cloud environment. The application includes a first object that is configured to call a second object of the application as part of transaction execution. The partial migration includes migrating the first or second object to the cloud environment and providing a façade that calls to a proxy API to facilitate connecting the call made by the first object to the second object. Also provided is multi-phase commit transaction support when a transaction initiated on the cloud includes elements that execute on a mix of the cloud environment and the mainframe.

### BACKGROUND

Historically, many backend software applications, such as those hosted on a mainframe or legacy server/system, are composed of a collection of programs that are relatively tightly coupled to each other and possibly other backend components, such as database(s). A backend application is sometimes written in a legacy programming language like COBOL, and can be very large and complex.

### SUMMARY

Shortcomings of the prior art are overcome and additional advantages are provided through the provision of a computer-implemented method. The method partially migrates to a cloud environment an application configured for execution on a mainframe system, the application including a first object that is configured to call a second object of the application as part of transaction execution. The partially migrating includes migrating the first object to the cloud environment for execution thereon, providing in the cloud environment a façade component that receives from the first object the call to the second object, and providing a proxy component exposing an application programming interface (API) for calling by the facade component, the proxy component providing a call to the mainframe system for provision to the second object on the mainframe system.

Another embodiment of a method includes partially migrating to a cloud environment an application configured for execution on a mainframe system, the application including a first object that is configured to call a second object of the application as part of transaction execution, and the partially migrating includes migrating the second object to the cloud environment for execution thereon, providing in the mainframe system a facade component that receives from the first object the call to the second object, and providing a proxy component exposing an application programming interface (API) for calling by the facade component, the proxy component providing a call for provision to the second object on the cloud environment.

Yet further, an embodiment of a method includes partially migrating to a cloud environment a transaction flow configured for execution on a mainframe system, the transaction flow including a sequence of actions performed by execution of a plurality of objects, the plurality of objects including a first object configured to call a second object as part of the transaction flow, and the partially migrating includes migrating the first object to the cloud environment for execution thereon as part of the transaction flow, and providing in the cloud environment a façade component that receives from the first object the call to the second object, and calls to the second object through a mainframe gateway to invoke execution of the second object on the mainframe system.

Computer systems that include a memory and a processor in communication with the memory, and that are configured to perform methods described herein are also provided. Additionally, computer program products that include a computer readable storage medium readable by a processing circuit and storing instructions for execution by the processing circuit for performing methods described herein are also provided.

Additional features and advantages are realized through the concepts described herein.

For instance, in some embodiments, the first object, second object, and façade are each written in a same programming language.

Additionally or alternatively the method includes providing a gateway component, where the proxy component invokes the gateway component via another API, and the gateway component provides the call to the second object. Optionally, the proxy component invokes the gateway component via an HTTP call and the gateway translates the HTTP call into a native mainframe call provided to the second object.

Additionally or alternatively, the proxy component is provided as a microservice on the cloud environment and the facade (if on the cloud) calls the proxy component via RESTful communication, or the façade (if on the mainframe side) calls the proxy component via hypertext transfer protocol (HTTP).

Additionally or alternatively the proxy component is provided as part of a container executing on the cloud environment.

Additionally or alternatively, the proxy component could invoke a mainframe gateway component via RESTful communication, and the mainframe gateway could translate the HTTP call into a native mainframe call provided to the second object.

Additionally or alternatively, the second object can execute in the cloud environment as part of a microservice. Optionally, the proxy component is provided as part of another microservice, separate from the microservice as part of which the second object executes.

In a method that partially migrates to a cloud environment a transaction flow, the transaction flow can include a multi-phase commit transaction. Communication between the first object executing in the cloud environment and the second object invoked for execution on the mainframe system, including the call from the first object to the second object, can include HTTP-based communication via one or more application programming interfaces. The first object can maintain a state of the multi-phase commit transaction in the cloud environment, and the call to the second object can invoke on the mainframe one (or more) mainframe-side transaction(s). Additionally or alternatively, the first object can execute as part of a microservice in the cloud environment. Additionally or alternatively, the first object, second object, and façade are each written in a same programming language, and the call can include a payload passed from the first object through the mainframe connector to the second object.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example mainframe computing environment hosting an application that is configured for execution thereon;

FIG. 2 depicts an example in which the application of FIG. 1 has been partially migrated to a cloud environment, in accordance with aspects described herein;

FIG. 3 depicts another example in which the application of FIG. 1 has been partially migrated to a cloud environment, in accordance with aspects described herein;

FIG. 4 depicts yet another example in which the application of FIG. 1 has been partially migrated to a cloud environment, in accordance with aspects described herein;

FIG. 5 depicts a further example in which the application of FIG. 1 has been partially migrated to a cloud environment, in accordance with aspects described herein;

FIGS. 6-7 depict example processes for partially migrating to a cloud environment an application configured for execution on a mainframe system, in accordance with aspects described herein;

FIG. 8 depicts an example process for partially migrating to a cloud environment a transaction flow configured for execution on a mainframe system, in accordance with aspects described herein; and

FIG. 9 depicts one example of a computer system and associated devices to incorporate and/or use aspects described herein.

### DETAILED DESCRIPTION

Described herein are approaches for at least partial migration of applications from mainframe or other backend systems to cloud environments, such as public, private, and/or on-premises cloud environments implemented using desired cloud technologies. Circumstances such as those noted above drive a desire to at least partially migrated an application to a more modern environment because of various advantages that are gained from doing so. Aspects described herein can aid in large-scale migrations that are to be completed incrementally, as well as migrations intended to remain partial, i.e. to retain some processing on the backend (e.g. mainframe) on a permanent or semi-permanent basis. Either form of partial migration relies on bidirectional interactions with workloads that remain on the mainframe at both the compute and datastore levels. In practice, application objects (also termed modules or programs) migrated to the cloud might dialog with transaction(s) remaining on the mainframe, for instance on a mainframe transactional monitor/manager application. Example such transaction management applications are those of the Customer Information Control System (CICS®) line of offerings by International Business Machines Corporation (of which CICS is a registered trademark).

Accordingly, bidirectional connectivity is provided as described herein between (i) programs, of an application, partially migrated out to a cloud platform and (ii) program(s), of that application, that remain on the mainframe. Specifically, aspects provide connectivity for both (i) situations where transactions are initiated on the mainframe and rely on cloud processing, and (ii) situations where transactions are initiated on the cloud and rely on mainframe processing. The gradual migration of application components—referred to as “phased migration”—to support such functionality has been difficult to achieve.

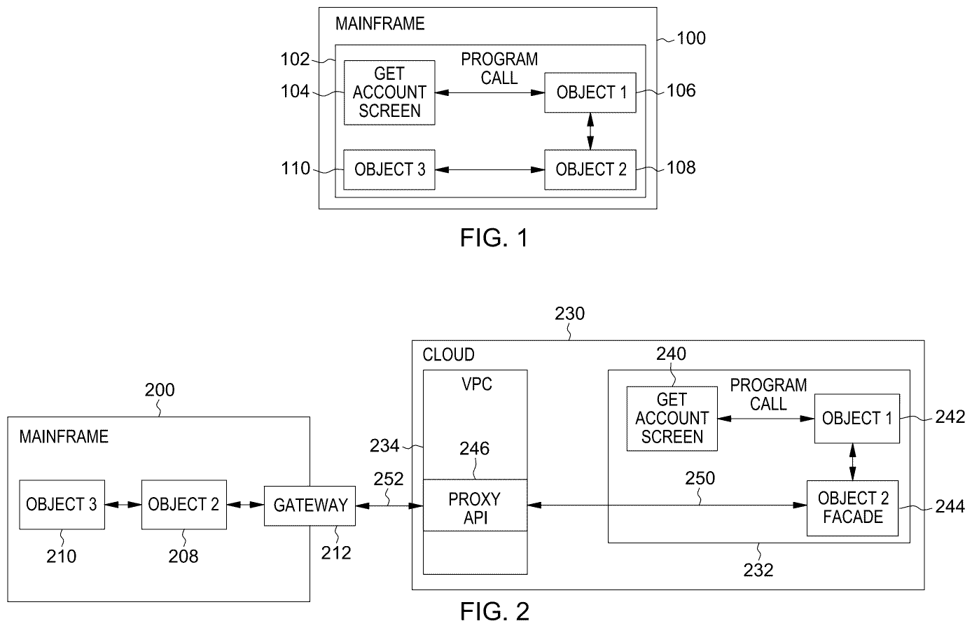

Referring to FIG. 1, depicted is an example mainframe computing environment 100 hosting application 102 that is configured for execution thereon. Application 102 is composed of components (also referred to herein as “objects” and “programs”), which are entities that run/execute on processor(s)/processing circuit(s) of the mainframe environment. Environment 100 includes one or more computing systems (servers, as an example) to execute software, including application 102.

Shown are four objects of application 102 in this example. The first is a mainframe interface screen 104 for input/output (I/O) (referred to as the “Get Account Screen”) that defines fields allowing input of information. Typically, a user inputs information and strikes the Enter key of a keyboard to cause submission of the input information. This causes a program call to be made to program code (such as COBOL code) of another object to parse that information and invoke additional transaction processing. In this example, the three other programs are 106 (“Object 1”), 108 (“Object 2”) and 110 (“Object 3”). As one example, programs 106, 108, 110 can compose a transaction, initiated from/via the interface screen 104, that rely on I/O from one or more databases and potentially other components (not pictured). Get Account Screen (104) makes a program call to Object 1 (106), which executes and makes a program call to Object 2 (108), which itself executes and makes a program call to Object 3 (110) to execute. This is just one example application and transaction flow; other applications might include other numbers of objects invoked in any of a variety of sequences. In the case of FIG. 1, the objects are written in a same programming language, such as COBOL.

An approach for application migration might seek to migrate all functionality of application 102. For instance, the approach might move the application to a cloud platform that mimics the mainframe platform. Alternatively, the approach might use code conversion that converts the program code of the objects (COBOL in this example) to another language, such as Java, to perform on the cloud platform the same or similar functions that the objects perform on the mainframe. This is referred to as “re-platforming” or “re-engineering”.

Aspects described herein enable partial migration, in which only a subset of the application, rather than the entirety, is migrated to and executes on the cloud environment. Such partial migration might proceed in stages in which, over time, more functionality (in the form of discrete application objects) is migrated away from the mainframe/backend and to the cloud—a process referred to as phased migration.

FIG. 2 depicts an example in which the application of FIG. 1 has been partially migrated to a cloud environment, in accordance with aspects described herein. Specifically, a subset of the program(s) of the application have been migrated to a cloud platform, while the remaining program(s) of the application remain on the backend for calling from the cloud to execute on the mainframe. FIG. 2 depicts an example in which interface screen 104 and Object 1 (106) of FIG. 1 have been migrated to the cloud but other objects (e.g., 108 and 110) remain on the backend. In this situation, some application components have moved to another hardware platform, but overall application functionality is retained.

With reference to FIG. 2, cloud environment 230 refers to one or more cloud environment hosts/providers. Cloud environments could be public, private, hybrid, or on-premises, as examples. Environment 230 hosts modernization target environment (MTE) 232 and virtual private cloud (VPC) environment 234. The MTE 232 provides a re-platforming pattern to which the interface screen (104 of FIG. 1) and Object 1 (106 of FIG. 1) are moved and hosted, i.e., as screen 240 and Object 1 (242). A transaction initiated via screen 240 begins in the cloud but access is still needed to application objects 2 and 3 that remain hosted on the mainframe, i.e. as Object 2 (208) and Object 3 (210). A call out to the backend mainframe 200 is therefore provided for invocation from the cloud environment 230 into the backend mainframe 200 as explained. The migrated objects 104, 106 (as objects 240, 242 running in the cloud) may be written in any desired language, for instance the original COBOL code if the MTE 232 allows rehosting, or another code if the MTE 232 provides for replatforming, in which the original code is translated into another code (e.g. java) for hosting, as an example.

Specifically, one aspect of a solution creates a façade object 244 in cloud environment 230 to provide a link between Object 1 (242), as the caller on the cloud, and Object 2 (208), as the callee on the mainframe 200. “Stub” may be used herein to refer to object 244 from the caller perspective and “façade” may be used herein to refer to object 244 from the callee perspective, though the two words may be used interchangeably herein to refer to the linking object between the callee and caller. The façade/stub works directly with mainframe gateway component (gateway 212) to interface caller objects with callee objects.

By way of specific example, in FIG. 1 the call made from application Object 1 (106), as caller, to Object 2 (108), as callee, may be an EXEC CICS LINK call. Façade 244 of FIG. 2 is therefore configured to accept this type of call/communication from the (migrated) Object 1 (242) as such and convey an appropriate communication to Object 2 (208) just as if Object 1 remained executing on mainframe 100 as object 106. The migration of objects 104 and 106 into the cloud (as objects 240 and 242) may desirably be transparent to the mainframe application components. Accordingly, façade 244 acts as a façade of object 2, accepting the call from Object 1 (242) and providing (via proxy application programming interface (API) 246 of the VPC 234 and gateway 212) a communication to Object 2 (208) on mainframe 200. By way of specific example, a ‘ghost’ transaction to which the other components are oblivious may be made to channel the call from Object 1 (242) through proxy API 246 and gateway 212 to Object 2 (208) to provide the transaction communication/call transparently from the cloud environment 230 to the mainframe 200.

In this example, communication between façade 244 and proxy API 246 is by way of REST (REpresentational State Transfer) call(s), and the cloud environment 230 communicates with the mainframe environment 200 (e.g. via gateway 212) through HTTP/s (Hypertext Transfer Protocol) call(s). For instance, proxy API 246 receives a REST call from façade 244 over wired/wireless communication link 250 and issues an HTTP/s call over wired/wireless communication link 252 to activate gateway component 212. Gateway 212 translates the HTTP/s call into a native mainframe call that gateway 212 makes to Object 2 (208), since Object 2 is expecting to receive calls in the native mainframe format. Object 2 (208) is, as explained above, an executable module. Initially, prior to the mainframe call made to it by/from the gateway 212), Object 2 (208) may be idle/not executing but may wake/execute upon/based on the call made to it by gateway 212. Object 2 (208) can call to Object 3 (210) per normal application (102) behavior and in the native format, receive from Object 3 (242) a response, and deliver a response that is sent back to Object 1 (242) on the cloud via the same communication link, i.e., sent back to the gateway 212 via a native mainframe interface, and from there via HTTP/s to proxy API 246, which returns a REST response to façade 244 for provision of a response to Object 1 in the format in which Object 1 (242) expects it to be.

Façade 244, after receiving Object 1's call for Object 2, creates a call of Object 2 (208, located on the mainframe) and knows how to convey this through the proxy 246 to the gateway 212, which itself knows how to call Object 2 (208) in the native mainframe format just as if Object 1 were executing on the mainframe and had called Object 2 directly. Proxy API 246 can provide a non-public (i.e. unpublished) API, for instance. Additionally, façade 244 can be specific to Object 1 (242) such that it may be implemented as a lightweight component and minimally configured to accept Object 1's call to Object 2 and provide it as a communication to proxy API 246. Object 1 of application 102 may be written in COBOL, and therefore façade 244 may also be written in COBOL, if desired. In some examples, the creation of the façade may be automated, based directly from the code (e.g. COBOL) of the caller and callee. For instance, a process can understand from the code of the caller and callee what the call between them is to look like and can additionally understand how to communicate between the cloud environment 230 and the external (mainframe) environment 200 without losing the COBOL-to-COBOL (in this example) simplicity. The creation of an appropriate façade can be automated from that information. A façade therefore provides an adapter that adapts the single-environment program call on the mainframe (e.g. the call from Object 1 to Object 2 of FIG. 1 in this example) to a cross-environment invocation from cloud to mainframe (i.e. as in FIG. 2).

From the perspective of caller Object 1 (242) on the cloud, but perhaps unbeknownst to Object 1, Object 2 has been replaced with a stub 244 in the sense that Object 1's call flows to stub 244 rather than directly to Object 2 executing on the mainframe. Stub 244 invokes a function of proxy API 246 through REST call(s). In examples, proxy API 246 executes as part of a microservice hosted by a microservice platform of VPC 234 and exposes REST APIs for general purpose use. By “general purpose” means that the REST API(s) can, if desired, be invokable from multiple different sources, such as various sources executing in MTE 232, on the cloud platform 230 generally, or elsewhere. In this example, it is invoked from MTE 232, specifically façade 244 thereof.

Proxy API 246 may be in communication with gateway 212 via a site-to-site virtual private network connection, for instance, as communication link 252. In examples, a COBOL (or other code-based) payload message from the Object 1 program (242) is provided via façade 244 and proxy API 246 through gateway 212 to Object 2 (208). The proxy API 246 may have the ability to take the data format provided by the façade (COBOL in this example) and provide the message in the format needed on the mainframe, which in these examples also happens to be COBOL. Object 1's (242) call and the API call made by façade 244 might expect a return/response from mainframe 200, which could therefore travel from through gateway 212 to proxy API 246, then to façade 244 and Object 1 (242).

Optionally, an orchestration engine could provide additional logic when desired in conjunction with façade processing and/or proxy API processing. By way of example, it may be desired to combine multiple transactions together and/or to manipulate transaction flow, for instance by adding additional business logic, error handling, high availability features, or any other concern to the flow, in which case an orchestration engine can be implemented via the proxy API and/or façade component(s) involved to orchestrate this activity.

Accordingly, in an environment in which an application that is configured for execution on a mainframe system is to be partially migrated to a cloud environment, where the application includes (at least) a first object (a caller) that is configured to call a second object (a callee) as part of transaction execution, a process can partially migrate the application to the cloud environment. The process to partially migrate can be partially or wholly automated. This partial migration can include migrating the first object (caller) to the cloud environment for execution thereon, providing in the cloud environment a façade/stub component that receives from the first object the call to the second object (the callee), and providing a proxy component (such as a proxy API running as microservice) exposing an API for calling by the facade component, where the proxy component provides a call to the mainframe system (such as a gateway between the mainframe and the cloud) for provision to the second object (callee) on the mainframe system. Instead of the first object's call being made on the mainframe to the second object (as in FIG. 1), the call of the first object flows to the façade component, which is responsible for invoking the second object on the mainframe. As noted, the second object could be an executable module that is not running initially, when the call is made, but that starts/commences execution in response to the gateway calling to the second object.

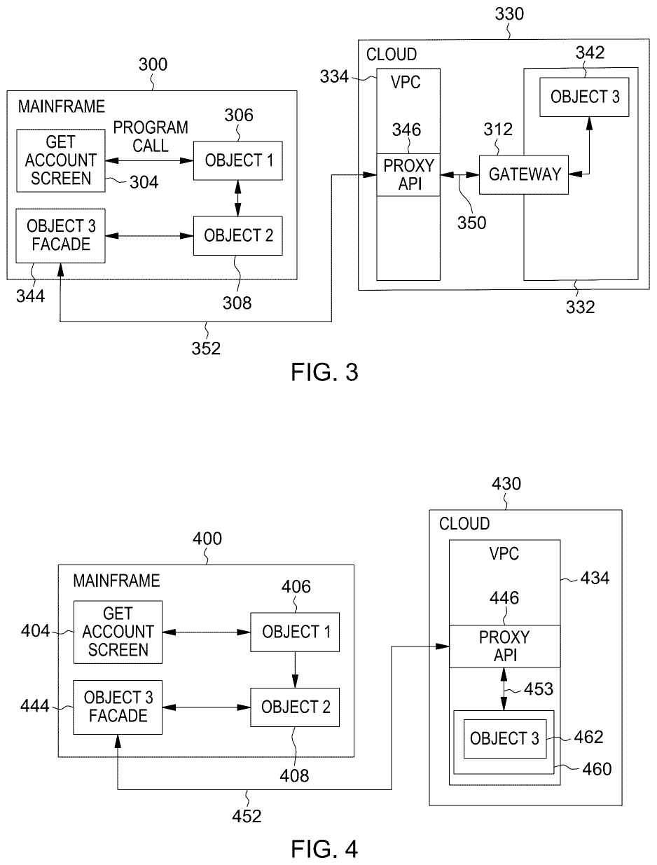

FIG. 3 depicts another example in which the application of FIG. 1 has been partially migrated to a cloud environment, in accordance with aspects described herein. Like-termed components across the figures may be analogous unless otherwise specified. FIG. 3 presents an example in which application components 104, 106 and 108 remain on the mainframe (as 304, 306, 308 on mainframe 300) but Object 3 (110 of FIG. 1) has been migrated to a cloud environment 330, which has MTE 332 and VPC 334. Here, a transaction is initiated via screen 304 on mainframe 300, which proceeds to Object 1 (306), then Object 2 (308), both via native mainframe communication. Eventual transaction processing, via Object 3 (342), reaches the cloud. An Object 3 façade 344 on the mainframe is provided, again written in COBOL for example, to accept communication from Object 2 (308) in native mainframe format and invoke via HTTP/s communication along wired/wireless communication link 352 a proxy API 346 (deployed as a microservice, for instance). Façade 344 makes a REST API call to proxy API 346, for example. Proxy API 346 can receive the COBOL (in this example) binary payload and make HTTP/s call(s) over wired/wireless communication link 350 to invoke gateway 312 to communicate to migrated Object 3 (342). Object 342 may be written in java code or COBOL code, for example. The façade/stub 344 in the mainframe 300 is written in COBOL, for instance, and calls through the proxy API 346 to gateway 312 for communication to Object 3 (342). The communication between gateway 312 and object 3 342 may be in the native (to Object 3) protocol (for example COMMAREA in the example of CICS).

Accordingly, in an environment in which an application that is configured for execution on a mainframe system is to be partially migrated to a cloud environment, where the application includes (at least) a first object (a caller) that is configured to call a second object (a callee) as part of transaction execution, a process can partially migrate the application to the cloud environment. The process can be partially or wholly automated. This partial migration can include migrating the second object (callee) to the cloud environment for execution thereon, providing in the mainframe system a façade/stub component that receives from the first object the call to the second object (the callee), and providing a proxy component (such as a proxy API running as microservice) exposing an API for calling by the facade component, where the proxy component provides a call for provision to, e.g. a gateway, for provision to the second object (callee) on the cloud environment. Instead of the first object (the caller, Object 2 in FIG. 3) calling the second object (callee, Object 3) on the mainframe (as in FIG. 1), the first object calls the façade component that is responsible for invoking the second object (callee, Object 3) on the cloud environment. As noted, the second object could be an executable module that is not running initially but that starts/commences execution once called by gateway 312.

Between the approaches in FIG. 2 and FIG. 3, the solution creates the stubs/facades as needed on either side (cloud and mainframe) to ensure that previous links between caller and callee components remain transparently intact for the caller and callee between the mainframe and the cloud environment. It is noted that applications being migrated can be of varying complexity and therefore there may be one or more façade(s) established on the mainframe and/or one or more cloud platforms depending on which, and where, objects are migrated. Furthermore, there might be one or multiple transaction communications flowing between the cloud and the mainframe as part of one or multiple transactions being initiated and performed.

It is further noted that the gateway component (e.g. 212, 312) may be optional, as the proxy API may be configured to call to the callee object directly, if desired.

Various different types of platforms (cloud and backend) and connectors for communicating between the platforms may be supported by tailoring the activity and configuration of the proxy API and stub/façade components accordingly. Supported protocols and features can include transactionality, encryption and end-point authentication, and integration with services/features of major cloud platforms. The following are example connectors and mainframe technologies/software that may be supported: CICS® native, CICS® Transaction Gateway, IMS (Information Management System) Connect via library and/or Transmission Control Protocol (TCP) native for older IMS, IMS DB, IBM MQ, DB2® z/OS®, TSQ (Temporary Storage Queues), 3270, Virtual Storage Access Method (VSAM)/Generation Data Group (GDG) via File Transfer Protocol (FTP)/Job Control Language (JCL), Natural ADABAS®, COBOL, PL/I, z/VSE®, and enterprise software offered by Micro Focus International plc, Newbury, England (CICS, IMS, MQ, DB2, z/OS, TSQ, 3270, and z/VSE are all offerings of International Business Machines Corporation, of which CICS, DB2, z/OS and z/VSE are registered trademarks; Natural ADABAS is an offering of Software AG, of which ADABAS is a registered trademark). In examples, transactionality is supported for IMS and DB2, and CICS via CTG. All connectors may support encryption (Secure Sockets Layer (SSL)/Mutual Transport Layer Security (mTLS). For end-point authentication, it is noted that most connectors can support Resource Access Control Facility (RACF) and basic authentication.

FIG. 4 depicts yet another example in which the application of FIG. 1 has been partially migrated to a cloud environment, in accordance with aspects described herein. FIG. 4 is similar to FIG. 3 in that the interface screen 404, Object 1 (406), Object 2 (408) and façade 444 run in mainframe 400, and façade 444 communicates via wired/wireless communication link 452 with proxy API 446 executing on the VPC 434 of cloud platform 430. Here, however, Object 3 (110 of FIG. 1) has been migrated and packed into microservice 460 as component 462 using COBOL to java conversion. Whereas the examples of FIGS. 2 and 3 migrate mainframe objects to a rehosting/replatforming MTE to host objects in a platform built to mimic the mainframe, the migrated object in the example of FIG. 4 is wrapped into a microservice instead, which avoids a need to mimic the mainframe infrastructure in an MTE. In FIG. 4, façade 444 communicates via HTTP/s over link 452, and proxy API 446 communicates with microservice 460 within VPC 434 over wired/wireless/data communication link 453 using whatever is supported by the converted Object 3 (462).

Thus, in accordance with aspects of FIG. 4, the callee object (462) executes in the cloud environment as part of a microservice (460), and proxy component (446) is provided as part of another microservice, separate from microservice 460 as part of which the callee (462) executes (though they could instead be provided as a single microservice, if desired, or elsewhere in the cloud platform 430).

It is also noted that FIG. 4 does not include the gateway component interfacing the caller and callee (as 212 of FIG. 2; 313 of FIG. 3). In this regard, an API gateway could be used along link 452 as is the case with FIGS. 2 and 3, but is not necessary, as is reflected here.

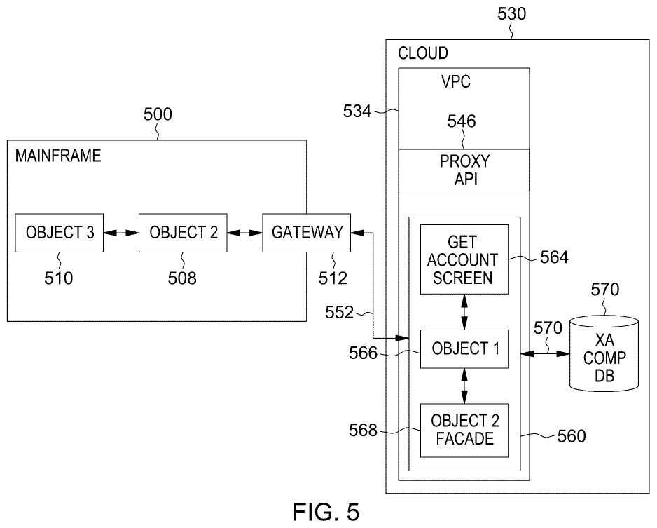

The example of FIG. 4 depicts mainframe-initiated transaction processing that extends to Object 3 in the cloud. Another example in which the application of FIG. 1 has been partially migrated to a cloud environment in accordance with aspects described herein is shown in FIG. 5, in which transaction processing is cloud-initiated and extends back to the mainframe. Referring to FIG. 5, cloud platform 530 includes VPC 534 hosting proxy API 546 and microservice 560. The functionality of interface screen 104 and Object 1 (106) of FIG. 1 has been migrated to the cloud, specifically as components 564 and 566, respectively, of microservice 560, from COBOL to java conversion. Microservice 560 also provides an Object 2 façade (568) for calling via HTTP/s (as one example) over communication link 552 through mainframe gateway 512 into mainframe 500, which continues to host Object 2 (as 508) and Object 3 (as 510). Gateway 512 calls to Object 2 (508), and Object 2 (508) calls to Object 3 (510), using the native mainframe protocol. As noted above, façade 568 could be auto-generated based on knowledge of the legacy call made by the caller Object 1 to callee Object 2. In this example, the proxy API 546 is not utilized when calling into the mainframe, with gateway 512 instead acting as the middleware when calling into the mainframe.

Aspects of partial migration as described herein in which application objects are migrated to a cloud platform can advantageously leverage and/or support microservice/serverless architectures out of the box, run migrated/converted COBOL (as an example) inside such microservices/serverless technologies, utilize a common/same software development kit (SDK) for whatever mainframe connector(s), MTE, migration service (such as Blu Age offered by Amazon. com Inc., Seattle, Washington), and code conversion tool(s) are utilized, and support a variety of programming languages/frameworks such as Java, Kotlin, Spring, node.js, and C #(as examples) to support enrichment and customization, and take advantage of framework capabilities. The approach enables API design and orchestration, and the migrated elements can be implemented by relatively lightweight runtime components (in java and/or native language, for instance).

Example migrations beginning with tightly-coupled programs of a mainframe application can eventually translate those programs to Java or another more modern language/framework, splitting individual components into microservices all eventually residing in the cloud (“service extraction”). Initially, the microservices will need interfaces for communicating between them and the mainframe, and it may eventually be desired to provide customization of each of these. Thus, it might be necessary to move objects in phases, which results in incremental, partial migration to microservice(s), and provide innovations on those microservices as desired to augment functionality, for example. Aspects described herein dealing with partial migration scenarios may be useful during this transition period when some application components have been migrated, but others remain on the mainframe until they are able to be migrated.

Another problem existing in the domain of partial migration is transaction management, and particularly multi-phase commit transactions that are initiated in the cloud but rely on processing executed on the mainframe. Using a two-phase commit by way of example, program A on the cloud might perform certain logic and call program B on the mainframe to perform other logic, all within the context of a surrounding transaction. If one of these constituent programs of the transaction fails, then the whole transaction should fail. If not orchestrated properly, data inconsistency or other issues can result. In the context of partial migration, in which processes run in each of multiple places, conventional two-phase commit (or more generally multi-phase commit) processing does not work. For instance, a two-phase commit call from the cloud to the mainframe might invoke processing on the mainframe that returns successfully, however subsequent processing (in the cloud for instance) might fail. The issue is how to unwind (rollback) what of the multi-phase commit transaction has completed to that point. Conventionally, with the application contained with the mainframe, the mainframe could maintain state information to properly undo prior activity in a rollback situation. This is also true in situations where the transaction is initiated on the mainframe and reaches out to the cloud for some phase(s) of the transaction; the existing multi-phase commit orchestration facility of the mainframe could be used. However, a problem exists in the situation where the transaction is initiated on the cloud and performs processing that reaches out to the mainframe for phase(s) of the transaction, as the mainframe orchestration facility is not available to orchestrate the transaction. Further, orchestration relies on maintaining state, which is problematic in scenarios as described herein involving RESTful communication, since REST APIs are, by definition, stateless.

Still referring to FIG. 5, database (DB) 570 is maintained in the cloud and used by microservice 560 in transaction processing, specifically a multi-phase transaction that performs data manipulation for updates on two systems, e.g. mainframe 500 and cloud 530. The transaction is to be run in microservice 560, which communicates with DB 570 over wired/wireless communication link 570. Object 1 (566) component—Java code converted from the COBOL code of Object 1 (106), for instance—is performing a transaction using DB 570 that is compatible with multi-phase commit processing and is communicating, via façade 568, with mainframe 500 on the backend to invoke data manipulation on the mainframe. These activities perform an overall transaction that is shared between programs (564, 566) in microservice 560 and programs (508, 510) on mainframe 500. In this approach, a main transaction is running inside of microservice 560 and is performing a multi-phase commit transaction with transaction(s) running on mainframe 500.

In connection with this approach, transaction state(s) can be maintained on the cloud platform for each of the call(s) made back to mainframe 500. For instance, transaction state is maintained by the 2PC (two-phase commit) protocol and a JAVA open source implementation of 2PC, for instance the Narayana Transaction Manager. Microservice 560 can monitor these states and wait to ‘close’ the main transaction until the individual calls, corresponding to transaction(s) on the mainframe all ‘close’ by returning successfully. Similarly, the states of transaction processing performed on the cloud may be monitored. In conjunction with the states, a counter may be maintained. Assuming all constituent actions of the overall transaction are successful, then the multi-phase commit can be completed successfully. For instance, an orchestrator running inside of the microservice triggers the commit protocol to transaction participants.

In terms of dealing with failure situations, microservice 560 is aware of which call(s) to the mainframe completed successfully (thereby resulting in changes on the mainframe), and which failed. Similarly, microservice 560 is aware of the success or failure of actions performed on the cloud side as part of the transaction. Microservice 560 can therefore reverse any of the changes that were made. For instance with respect to the mainframe-side changes, microservice 560 can issue the proper call(s) to the mainframe to undo the changes thereon that need to be rolled-back. In this manner, multi-phase commit processing is enabled despite use of RESTful APIs, which are stateless, by way of maintaining a state in the microservice.

Accordingly, in some aspects a transaction flow configured for execution on a mainframe system can be partially migrated to a cloud environment. The transaction flow includes a sequence of actions performed by execution of obejcts, where the objects include a first object (caller) configured to call a second object (callee) as part of the transaction flow. Partially migrating the transaction flow can include migrating the first object (caller) to the cloud environment for execution thereon as part of the transaction flow, and providing in the cloud environment a façade component that receives from the first object (caller) the call to the second object (callee), and calls to the second object through a mainframe gateway to invoke execution of the second object (called) on the mainframe system.

In embodiments, the transaction flow includes a multi-phase commit transaction, where communication between the first object (caller) executing in the cloud environment, optionally in or as a microservice thereof, and the second object (callee) invoked for execution on the mainframe system, including the call from the first object to the second object, includes HTTP-based communication via one or more APIs. The first object (caller) on the cloud can maintain a state of the multi-phase commit transaction in the cloud environment, and the call to the second object (callee) can invoke on the mainframe a mainframe-side transaction. In some example multi-phase commit transactions, multiple (two or more) calls are made to the mainframe from the cloud to cause multiple separate actions on the mainframe, all within the context of the (one) multi-phase commit transaction. It is, however, possible that just one call is made to the mainframe with the rest of the processing occurring on the cloud side. Similarly, there may be one or multiple discrete transaction processing operations on the cloud side. Either way, state of the multi-phase commit transaction is maintained on the cloud and is used to commit all transaction actions, both on the cloud and on the mainframe, together (assuming all phases complete successfully) or rollback transaction actions as necessary, if one or more phases fail.

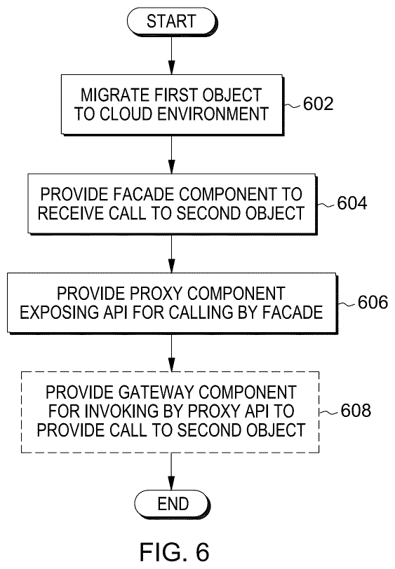

FIG. 6 depicts an example process for partially migrating to a cloud environment an application configured for execution on a mainframe system, in accordance with aspects described herein. The application includes a first object that is configured to call a second object of the application as part of transaction execution. The process includes migrating (602) the first object (possibly among other objects of the application) to the cloud environment for execution thereon, providing (604) in the cloud environment a façade component that receives from the first object the call to the second object, and providing (606) a proxy component exposing an application programming interface (API) for calling by the facade component. The proxy component provides/is configured to provide a call to the mainframe system for provision to the second object on the mainframe system. Optionally provided (608) also is a gateway component, wherein the proxy component invokes the gateway component via another API, and the gateway component provides the call to the second object.

In some embodiments, the proxy component invokes the gateway component via an HTTP call and the gateway translates the HTTP call into a native mainframe call that is provides to the second object.

In some embodiments, the first object, the second object, and the façade are each written in a same programming language, for instance COBOL.

In some embodiments, the proxy component is provided as a microservice on the cloud environment and the facade calls the proxy component via RESTful communication. Alternatively, the proxy component may be provided as part of a container executing on the cloud environment.

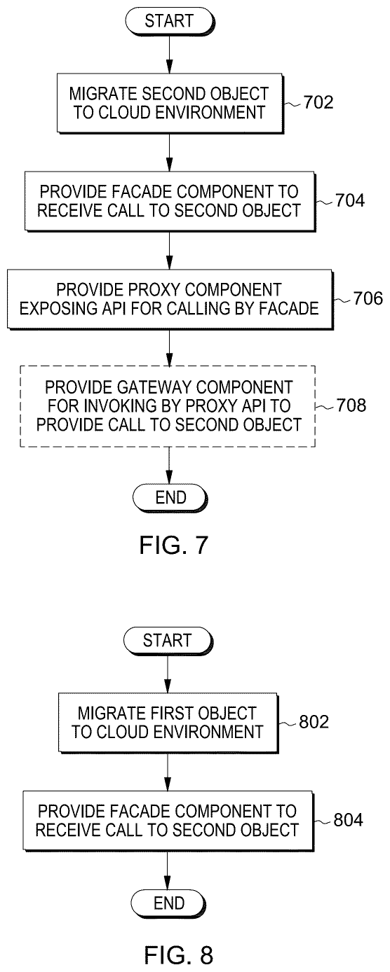

FIG. 7 depicts another example process for partially migrating to a cloud environment an application configured for execution on a mainframe system, in accordance with aspects described herein. The application includes a first object that is configured to call a second object of the application as part of transaction execution, and the process includes migrating (702) the second object (possibly among other objects of the application) to the cloud environment for execution thereon, providing (704) in the mainframe system a facade component that receives from the first object the call to the second object, and providing (706) a proxy component exposing an application programming interface (API) for calling by the facade component. The proxy component provides/is configured to provide a call to the mainframe system for provision to the second object on the mainframe system. Optionally provided (708) is a gateway component, wherein the proxy component invokes the gateway component via another API, and the gateway component provides the call to the second object.

In embodiments, the proxy component invokes the gateway component via RESTful communication and the gateway translates the HTTP call into a native mainframe call provided to the second object.

In embodiments, the first object, second object, and façade are each written in a same programming language, for instance COBOL.

In embodiments, the proxy component is provided as a microservice on the cloud environment and the façade component calls the proxy component via hypertext transfer protocol (HTTP). Alternatively, the proxy component may be provided as part of a container executing on the cloud environment.

In embodiments, the second object executes in the cloud environment as part of a microservice. In further embodiments, the proxy component is provided as part of another microservice, separate from the microservice as part of which the second object executes.

FIG. 8 depicts an example process for partially migrating to a cloud environment a transaction flow configured for execution on a mainframe system, in accordance with aspects described herein. The transaction flow can include a sequence of actions performed by execution of a plurality of objects. The plurality of objects include a first object configured to call a second object as part of the transaction flow. The process includes migrating (802) the first object (possibly among other objects of the application) to the cloud environment for execution thereon as part of the transaction flow, and providing (804) in the cloud environment a façade component that receives from the first object the call to the second object, and calls to the second object through a mainframe gateway to invoke execution of the second object on the mainframe system. In embodiments, the transaction flow includes a multi-phase commit transaction, and communication between the first object executing in the cloud environment and the second object invoked for execution on the mainframe system, including the call from the first object to the second object, includes HTTP-based communication via one or more application programming interfaces. The first object can maintain a state of the multi-phase commit transaction in the cloud environment, and the call to the second object invokes on the mainframe a mainframe-side transaction.

In embodiments, the first object executes as part of a microservice in the cloud environment.

In embodiments, the first object, second object, and façade are each written in a same programming language, and the call includes a payload passed from the first object through the mainframe connector to the second object.

Although various examples are provided, variations are possible without departing from a spirit of the claimed aspects.

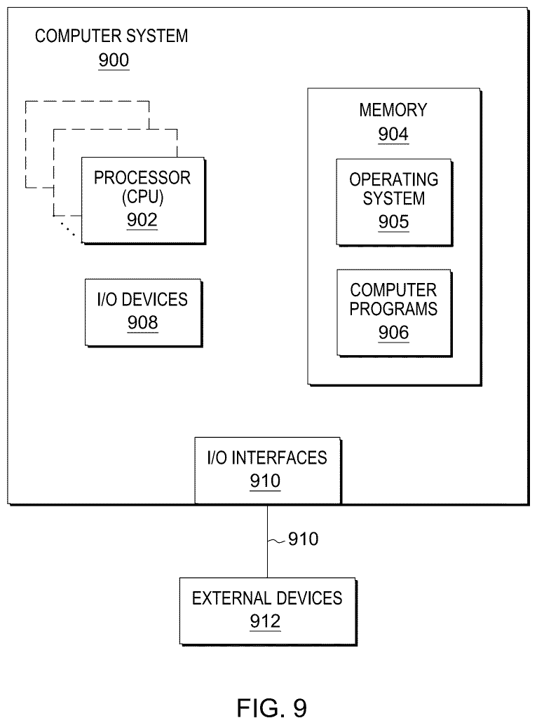

Aspects of processes described herein may be performed singly or collectively by one or more computer systems, such as one or more mainframe and/or cloud platform servers, as examples. FIG. 9 depicts one example of such a computer system and associated devices to incorporate and/or use aspects described herein. A computer system may also be referred to herein as a data processing device/system, computing device/system/node, or simply a computer. The computer system may be based on one or more of various system architectures and/or instruction set architectures, such as those offered by International Business Machines Corporation (Armonk, New York, USA) or Intel Corporation (Santa Clara, California, USA), as examples.

FIG. 9 shows a computer system 900 in communication with external device(s) 912. Computer system 900 includes one or more processor(s) 902, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 902 can also include register(s) to be used by one or more of the functional components. Computer system 900 also includes memory 904, input/output (I/O) devices 908, and I/O interfaces 910, which may be coupled to processor(s) 902 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 904 can be or include main or system memory (e.g. Random Access Memory) used in the execution of program instructions, storage device(s) such as hard drive(s), flash media, or optical media as examples, and/or cache memory, as examples. Memory 904 can include, for instance, a cache, such as a shared cache, which may be coupled to local caches (examples include L1 cache, L2 cache, etc.) of processor(s) 902. Additionally, memory 904 may be or include at least one computer program product having a set (e.g., at least one) of program modules, instructions, code or the like that is/are configured to carry out functions of embodiments described herein when executed by one or more processors.

Memory 904 can store an operating system 905 and other computer programs 906, such as one or more computer programs/applications that execute to perform aspects described herein. Specifically, programs/applications can include computer readable program instructions that may be configured to carry out functions of embodiments of aspects described herein.

Examples of I/O devices 908 include but are not limited to microphones, speakers, Global Positioning System (GPS) devices, cameras, lights, accelerometers, gyroscopes, magnetometers, sensor devices configured to sense light, proximity, heart rate, body and/or ambient temperature, blood pressure, and/or skin resistance, and activity monitors. An I/O device may be incorporated into the computer system as shown, though in some embodiments an I/O device may be regarded as an external device (912) coupled to the computer system through one or more I/O interfaces 910.

Computer system 900 may communicate with one or more external devices 912 via one or more I/O interfaces 910. Example external devices include a keyboard, a pointing device, a display, and/or any other devices that enable a user to interact with computer system 900. Other example external devices include any device that enables computer system 900 to communicate with one or more other computing systems or peripheral devices such as a printer. A network interface/adapter is an example I/O interface that enables computer system 900 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems (BLUETOOTH is a registered trademark of Bluetooth SIG, Inc., Kirkland, Washington, U.S.A.).

The communication between I/O interfaces 910 and external devices 912 can occur across wired and/or wireless communications link(s) 911, such as Ethernet-based wired or wireless connections. Example wireless connections include cellular, Wi-Fi, Bluetooth®, proximity-based, near-field, or other types of wireless connections. More generally, communications link(s) 911 may be any appropriate wireless and/or wired communication link(s) for communicating data.

Particular external device(s) 912 may include one or more data storage devices, which may store one or more programs, one or more computer readable program instructions, and/or data, etc. Computer system 900 may include and/or be coupled to and in communication with (e.g. as an external device of the computer system) removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media.

Computer system 900 may be operational with numerous other general purpose or special purpose computing system environments or configurations. Computer system 900 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like.

Aspects of the present invention may be a system, a method, and/or a computer program product, any of which may be configured to perform or facilitate aspects described herein.

In some embodiments, aspects of the present invention may take the form of a computer program product, which may be embodied as computer readable medium(s). A computer readable medium may be a tangible storage device/medium having computer readable program code/instructions stored thereon. Example computer readable medium(s) include, but are not limited to, electronic, magnetic, optical, or semiconductor storage devices or systems, or any combination of the foregoing. Example embodiments of a computer readable medium include a hard drive or other mass-storage device, an electrical connection having wires, random access memory (RAM), read-only memory (ROM), erasable-programmable read-only memory such as EPROM or flash memory, an optical fiber, a portable computer disk/diskette, such as a compact disc read-only memory (CD-ROM) or Digital Versatile Disc (DVD), an optical storage device, a magnetic storage device, or any combination of the foregoing. The computer readable medium may be readable by a processor, processing unit, or the like, to obtain data (e.g. instructions) from the medium for execution. In a particular example, a computer program product is or includes one or more computer readable media that includes/stores computer readable program code to provide and facilitate one or more aspects described herein.

As noted, program instruction contained or stored in/on a computer readable medium can be obtained and executed by any of various suitable components such as a processor of a computer system to cause the computer system to behave and function in a particular manner. Such program instructions for carrying out operations to perform, achieve, or facilitate aspects described herein may be written in, or compiled from code written in, any desired programming language. In some embodiments, such programming language includes object-oriented and/or procedural programming languages such as C, C++, C #, Java, etc.

Program code can include one or more program instructions obtained for execution by one or more processors. Computer program instructions may be provided to one or more processors of, e.g., one or more computer systems, to produce a machine, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A computer-implemented method comprising:
partially migrating to a cloud environment an application configured for execution on a mainframe system, the application comprising a first object that is configured to call a second object of the application as part of transaction execution, the partially migrating comprising:
migrating the first object to the cloud environment for execution thereon;
providing in the cloud environment a façade component that receives from the first object the call to the second object; and
providing a proxy component exposing an application programming interface (API) for calling by the facade component, the proxy component providing a call to the mainframe system for provision to the second object on the mainframe system.

2. The method of claim 1, wherein the first object, second object, and façade are each written in a same programming language.

3. The method of claim 1, further comprising providing a gateway component, wherein the proxy component invokes the gateway component via another API, and the gateway component provides the call to the second object.

4. The method of claim 3, wherein the proxy component invokes the gateway component via an HTTP call and the gateway translates the HTTP call into a native mainframe call provided to the second object.

5. The method of claim 1, wherein the proxy component is provided as a microservice on the cloud environment and the facade component calls the proxy component via RESTful communication.

6. The method of claim 1, wherein the proxy component is provided as part of a container executing on the cloud environment.

7. A computer-implemented method comprising:
partially migrating to a cloud environment an application configured for execution on a mainframe system, the application comprising a first object that is configured to call a second object of the application as part of transaction execution, the partially migrating comprising:
migrating the second object to the cloud environment for execution thereon;
providing in the mainframe system a facade component that receives from the first object the call to the second object; and
providing a proxy component exposing an application programming interface (API) for calling by the facade component, the proxy component providing a call for provision to the second object on the cloud environment.

8. The method of claim 7, wherein the first object, second object, and façade are each written in a same programming language.

9. The method of claim 7, further comprising providing a gateway component, wherein the proxy component invokes the gateway component via another API, and the gateway component provides the call to the second object.

10. The method of claim 9, wherein the proxy component invokes the gateway component via RESTful communication and the gateway translates the HTTP call into a native mainframe call provided to the second object.

11. The method of claim 7, wherein the proxy component is provided as a microservice on the cloud environment and the façade component calls the proxy component via hypertext transfer protocol (HTTP).

12. The method of claim 7, wherein the proxy component is provided as part of a container executing on the cloud environment.

13. The method of claim 7, wherein the second object executes in the cloud environment as part of a microservice.

14. The method of claim 13, wherein the proxy component is provided as part of another microservice, separate from the microservice as part of which the second object executes.

15. A computer-implemented method comprising:
partially migrating to a cloud environment a transaction flow configured for execution on a mainframe system, the transaction flow comprising a sequence of actions performed by execution of a plurality of objects, the plurality of objects comprising a first object configured to call a second object as part of the transaction flow, the partially migrating comprising:
migrating the first object to the cloud environment for execution thereon as part of the transaction flow; and
providing in the cloud environment a façade component that receives from the first object the call to the second object, and calls to the second object through a mainframe gateway to invoke execution of the second object on the mainframe system.

16. The method of claim 15, wherein the transaction flow comprises a multi-phase commit transaction, wherein communication between the first object executing in the cloud environment and the second object invoked for execution on the mainframe system, including the call from the first object to the second object, comprises HTTP-based communication via one or more application programming interfaces, wherein the first object maintains a state of the multi-phase commit transaction in the cloud environment, and wherein the call to the second object invokes on the mainframe a mainframe-side transaction.

17. The method of claim 15, wherein the first object executes as part of a microservice in the cloud environment.

18. The method of claim 15, wherein the first object, second object, and façade are each written in a same programming language, and wherein the call comprises a payload passed from the first object through the mainframe connector to the second object.

19-24. (canceled)

25. The method of claim 1, further comprising providing a gateway component, wherein the proxy component invokes the gateway component via another API, and the gateway component provides the call to the second object, and wherein the proxy component is provided:
as a microservice on the cloud environment and the facade component calls the proxy component via RESTful communication; or
as part of a container executing on the cloud environment.

26. The method of claim 7, further comprising providing a gateway component, wherein the proxy component invokes the gateway component via another API, and the gateway component provides the call to the second object, and wherein the proxy component is provided:
as a microservice on the cloud environment and the façade component calls the proxy component; or
as part of a container executing on the cloud environment.
